(19) United States
(12) Patent Application Publication
(10) Pub. No.: US 2004/0268386 A1
(43) Pub. Date: Dec. 30, 2004

(54) Virtual DVD library

(75) Inventors: James D. Logan, Candia, NH (US); Mark Pascarella, Boston, MA (US); Dana Burd, Charlestown, MA (US)

Correspondence Address: CHARLES G. CALL, 68 HORSE POND ROAD, WEST YARMOUTH, MA, 02673-2516, US

(73) Assignee: Gotuit Video, Inc.

(21) Appl. No.: 10/767,947

(22) Filed: Jan. 29, 2004

Related U.S. Application Data
(63) Continuation-in-part of application No. 10/165,587, filed on Jun. 8, 2002.
(60) Provisional application No. 60/443,378, filed on Jan. 29, 2003.

(51) Int. Cl. H04N 7/025; G06F 17/60; H04N 7/16; H04N 7/173; G06F 3/00; G06F 13/00; H04N 7/10

(52) U.S. Cl. 725/34; 725/35; 725/1; 725/86; 725/60; 725/61; 705/27

(57) ABSTRACT

A method for distributing media content using a video on demand (VOD) system or the like in which a collection of media content items, such as full length movies, is stored in one or more digital storage devices controlled by a content provider and coupled to a specific media presentation device such as a subscriber television set. VOD subscribers select desired content from a catalog of purchasable media assets, creating a sale contract which gives the user the right to present each purchased media content item in perpetuity and obligates said content provider to provide said user with substantially continuous access to said particular media content item as stored in said one or more digital storage devices controlled by said content provider.

### CROSS REFERENCE TO RELATED APPLICATION

This application is a non-provisional of, and claims the benefit of the filing date of, U.S. Provisional Patent Application Ser. No. 60/443,378 filed on Jan. 29, 2003 and is also a continuation in part of and claims the benefit of the filing date of U.S. patent application Ser. No. 10/165,587 filed on Jun. 8, 2002. This application incorporates the disclosures of both of those applications herein by reference.

### FIELD OF THE INVENTION

This invention relates to media distribution systems and more particularly, although in its broader aspects not exclusively, to methods and apparatus for distributing movies and other video content in a cable or satellite television system.

### BACKGROUND OF THE INVENTION

Consumers who purchase program content commonly purchase compact disk media (e.g. DVD and CD-ROM disks) containing recorded program content such as motion pictures and music. The creation of a library of content on media such as DVD or CD-ROM disks presents several disadvantages including the fact that they: take up space; can be lost, scratched or stolen; can be difficult to sort and organize; provide no convenient way to track what a user has seen or restart a movie or an album where it was being played earlier; make it difficult to restricting viewing to certain members of the household; and don't give the purchaser proper credit for multiple purchases.

Video-on-demand (VOD) systems enable viewers to purchase rights to programing content, typically movies, for use over a specified time period, and is comparable to renting a media volume containing the same content from a rental outlet. Nonetheless, there has been an increasing demand for “owned” content, and consumers are buying movie DVDs in large numbers when they could just as easily rent the same movies for about one-fifth the cost. It is apparent that consumers believe there is a significant benefit to owning the content, despite the fact that most movies are usually only watched once.

### SUMMARY OF THE INVENTION

The present invention takes the form of methods and apparatus that enable consumers to “purchase” virtual copies of an audio or video programming asset (which will be called “movies” or “programs” for convenience, but which can include audio content such as individual songs and albums of music, and video content including motion pictures, recorded sports events, and other video programming. The purchase of a virtual copy as contemplated by the invention permits substantially unlimited use of the content for a substantially unlimited time period and are hence called “Virtual DVDs” since they possess many of the same attributes of ownership of physical DVD volumes (or sets of volumes). The system provides numerous features and advantages not available through the purchase of physical media or the purchase of rights to content typified by existing VOD systems.

In accordance with the invention, an available collection of media content items is stored on one or more digital storage devices controlled by a content provider. These devices, which may include VOD servers at the headend or hub of a cable provider's system, or local “PVR” storage on the user's premises, are coupled to a specific media presentation device capable of rendering the content items in a form perceptible to the user,

The system further stores metadata describing each of the content items, and user data describing each participating subscriber and identifying the media content items which that subscriber has purchased, and the location(s) within each media item in said library where the presentation of that item may be commenced or resumed. The user data also preferably specifies number of times said user has accessed and used each media item in said library.

A catalog of available media items is first presented to the user and lists a subset of the content items that are available for purchase by the subscriber from a content provider. The contents of the subset may be specified by the user, and may include all available and previously unpurchased items that are in a particular category specified by the user. The contents of the subset may be based on the user's known preferences, either expressly stated by the user on inferred from the user's prior purchases or viewing history.

When the user makes a selection request identifying a particular media content item listed in a displayed catalog, a binding sales contract is created and recorded between the user and the provider which gives the user the right to present the purchased media content item in perpetuity, and obligates the provider to supply substantially continuous access to the purchased media content item as stored in the digital storage devices that are controlled by the provider.

In the event the provider is unable or unwilling to continue to provide access to the purchased media item, the provider may be obligated to enable the user to obtain the item recorded on one or more digital video disks. Alternatively, the provider may remove the copy protection which normally prohibits the high quality presentation of said particular media content item on any presentation device not authorized by said content provider, or refund the purchase price in whole or in part.

These and other features of the invention may be better understood by considering the following detailed description of an illustrative application of the principles of the invention to provide enhanced enjoyment of a video on demand cable system.

### BRIEF DESCRIPTION OF THE DRAWINGS

In the detailed description which follows, frequent reference will be made to the attached drawings, in which:

FIG. 1 is a block diagram of the principle hardware components used in an illustrative implementation of the invention.

### DETAILED DESCRIPTION

Hardware Architecture

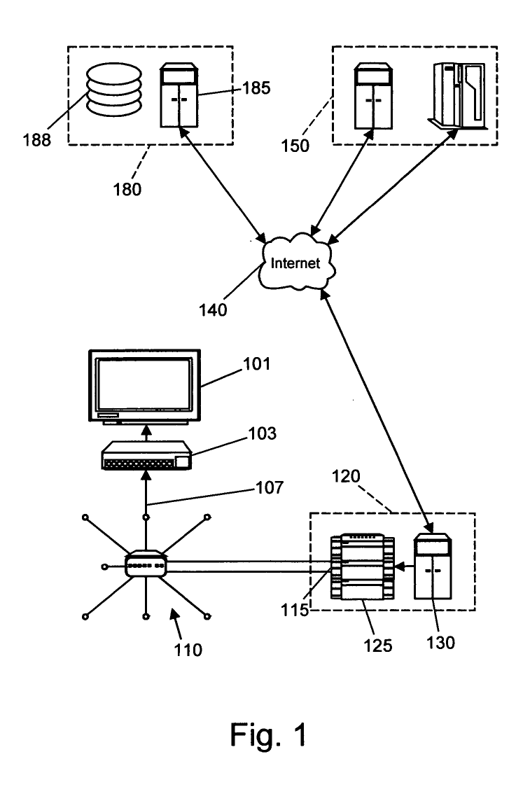

The present invention may be implemented in a variety of environments, one of which is illustrated in FIG. 1 of the drawings.

As contemplated by the invention, a user may employ conventional devices to view or listen to media content of the kind typically recorded on one or more media volumes, such as CD or DVD disks which store assets such as full-length movies, a collection of programs in a broadcast television series, music albums, and music videos. In the description that follows, the media assets most commonly referred to take the form of “movies” of the kind normally available for purchase on physical DVD disks, and the purchased access rights will frequently be referred to as a “Virtual DVD.” It should be understood, however, that the principles of the invention may also be applied to the “virtual purchase” of other kinds of assets, including music collections (“albums”) as sold on CD disks, movies and other video program content sold on cassette tape, and media programming which is available on the Internet or via a cable or satellite provider for purchase, downloading and recording on a DVD drive or the like.

In the illustrative embodiment of the invention to be described, a user typically watches video programming provided by a video on demand (VOD) cable system using a conventional television set 101 which receives programming via a connected “set top box” 103 that is in turn connected to cable system's facilities, including a subscriber cable 107 connected to a hub 110 that includes one or more edge servers which distribute programming to individual subscribers from the “headend” facility 120.

The set top box 103 is conventional and receives commands from a hand-held “remote control” device including a keypad that enables the user to navigate and make selections from menu choices displayed on the television set 101. The set top box 103 may also include a built-in digital video recorder which includes a hard disk memory that permits the user to locally store programs, including movies, received via the connected cable system. This locally stored content may be used alone, or in combination with storage available on the network that acts as a “networked personal video recorder” (nPVR). In addition, the user may employ a separate personal video recorder, such as those marketed by TiVo and ReplayTV. These PVR and nPVR units allow the user to pause, rewind and replay program material received via the cable system. The nPVR functions are typically provided as part of the cable vendor's VOD service which allow the user to watch programs selected from a catalog of currently available VOD offerings. Typically, when a user selects a given VOD program, it remains available for replay only for a limited amount of time, such as one day.

In contrast, when a media asset is purchased as a “Virtual DVD” as contemplated by the present invention, the user acquires virtual ownership of the purchased content, and may replay it as often, and for as long, as the user chooses, subject only to limited restrictions.

In the illustrative embodiment of FIG. 1, the edge server(s) in the hub receive MPEG-2 video over an IP/Gigabit Ethernet link 115 from a regional headend 120 which includes a video server farm 125. The edge servers at the hub 110 remove the Ethernet and IP headers, process and route the MPEG-2 video packets to the appropriate output, and QAM modulate and up-convert the signals for transmission over the subscriber cable 107 to the set top box 103. The downstream RF subscriber line connection between the hub 110 and the individual subscribers delivers content from the headend to the set-top box. This content includes video assets (programming), VOD catalog information, and other control information used by the VOD system. To efficiently provide VOD services to the subscriber, the provider may employ a hybrid architecture, locating VOD servers at both the headend and at the hubs. For example, an operator may choose to house a server with the ‘top hits’ at the hubs as well and use the headend server farm 125 to store the “deep library”. To provide VOD services comparable to those offered by an interactive cable system, satellite providers typically rely on local storage devices (hard disk storage units built into the set top box) to store media content which is broadcast to and saved by the set top box in advance of being viewed by the user.

One or more processors, such as the processor 130 seen in FIG. 1, are located at the cable headend 120 to perform content and business management functions. By way of example, the “OpenStream™ Complete VOD Solution” offered by N2 Broadband provides asset distribution and management, as well as business management, functions needed to implement VOD services. The asset distribution functions supervise the acquisition of content (media assets) which the headend receives by multicasting over satellite or via the Internet. The content is delivered to the headend's “catcher” which serves as temporary storage for assets before they are transferred to the video server farm 125. For example, the headend 120 may receive content via the Internet 140 from a content provider indicated generally at 160. The asset manager functions at the headend perform any processing required to modify provided metadata as needed for the video server(s), and stores, displays and, if necessary, edits the metadata used to describe the received assets. This metadata is stored in an asset database that provide capabilities such as an electronic program guide made available to the user. The headend processor 130 further performs business management functions, providing a link between the MSO's subscriber billing system and the VOD system.

The present invention may be used to enhance the capabilities of conventional VOD systems of the type described above by providing a mechanism that permits a subscriber to effectively “own” virtual copies of media assets, such as movies, that might be normally be purchased or rented for short term on physical media volumes, such as DVD disks, or provided for short-term use by the cable or satellite vendor's “pay per view” or VOD system. In accordance with the present invention, such assets may instead be purchased as a “virtual copy” providing the advantages of “ownership” as well as additional advantages which cannot be obtained by using purchased physical media volumes. These “virtual copies” may be stored, at any given time, in a variety of locations, including the storage facilities provided by a content provider 150, the headend 120 or hub 110 operated by a MSO, or on the local storage included in the set top box or a separate PVR on the user's premises.

The distribution and management of these “virtual copies” is performed under the supervision of a centralized “virtual asset distributor” seen at 180 which includes a virtual asset management processor 185 and a virtual asset database 188. The virtual asset distributor 180 performs some or all of the following principal functions:

1. Maintaining the virtual asset database 188 which, among other things, identifies the media assets to which purchasers may be given access pursuant to purchase contract;

2. Distributing metadata to prospective purchasers via VOD providers and the like in the form of a catalog of media assets which are available for purchase;

3. Establishing and maintaining customer records reflecting, for each customer, the identification of purchased assets, the terms upon which each purchased asset may be used by the customer, and a history of the actual use of that asset by the customer; and

4. Performing accounting functions for customer billing, payments between content providers and copyright holders, media distributors (such as cable and satellite providers), customers, and the virtual asset distributor.

Although, for purposes of explanation, the virtual asset distributor 180 is described as a separate entity, it should be understood that the virtual asset management functions can be performed and/or controlled by a content provider such as the provider 150, a media distributor such as the VOD provider operating the headend 120, or some combination of these entities. Moreover, although the virtual asset management functions, the content provision functions, and the cable headend processing functions are shown as being performed by different processors at different locations, these functions may be performed at the same location by the same or different processors.

Distribution

The steps performed to implement the virtual media asset distribution method contemplated by the invention reference may be performed in a VOD delivery system of the type shown in FIG. 1 and summarized above.

The method of distributing purchased virtual media content employs the step of sending a personalized “catalog” of available media items to the customer, with the contents of the catalog being identified by metadata transferred via the Internet from the virtual asset database 188 to the headend processor 130 which transmits the personalized catalog in viewable form for display on the television set 101 via the hub 110 and the set top box 103. The customer viewing the catalog on the television set 101 uses the interactive controls associated with the set top box 103 to select and purchase content from the catalog.

The content and organization of the catalog presented to the customer may be “personalized” in a variety of ways. Items in the user's existing “library” of purchased items are deleted from the catalog listing, since they need not be purchased again. The catalog may be presented to the user (potential customer) using a submenu which allows the user to select manner in which the offered items are listed. These presentation options may include:

a. Listing by genre. Each available item may classified by the metadata from the virtual asset database 188 in the in one or more categories: for example, Action, Biographical, Comedy, Documentary, etc. After the user has selected a category, the items in that category may then be displayed in a predetermined or selectable sort order (e.g., alphabetically by title or by popularity);

b. Listing by title. The customer might select one or more letters from the alphabet on a grid, and the system would respond by displaying all of the available items whose titles begin with those letters;

c. Recently or Previously viewed items. Items recently watched by that viewer (using that set top box), either as “free” broadcast or VOD programming, or previously “rented” using VOD or a pay-per-view service, could be listed for purchase. In addition, a customer may be given a “credit” toward the purchase price for items previously rented, thereby promoting rentals, since a customer would be aware that the rental cost could later be applied in whole or in part to the purchase price. Movies which have already been watched on “free” television might also be discounted to promote sales. The catalog could list of movies that have already seen, either using VOD, pay-per-view or “free” broadcasting. Since these items have been previously viewed, the provider could now apply discounted pricing to entice the viewer to watch a second time.

d. Suggested items. Items which are likely to match a given customer's taste may be included in a list of “suggestions” selected based an user's expressly stated preferences, the user's demographic characteristics (age, sex, geographic location, etc.), or the user's prior viewing and selection history (displaying items which have been popular with other viewer's who watched to same programming).

e. A “Wish List.” A user could identify particular items when “surfing” the program guide used to select live programming, or when viewing a pay- per-view or VOD catalog. In this way, a user could tag movies of interest and put them on the user's “wish list”. An item which is being advertised or previewed could be selected for inclusion on the wish list. By including an item on the wish list, a user could insure that items noted as being of interest would appear in the catalog when next presented, either with the other listed items or on a separate “wish list.”

To the extent items that are available for purchase (as identified by metadata from the asset management database 188) are also displayed in the electronic program guide, or in the guide to available pay-per-view or VOD items, as provided from the headend 120, the user could be given the option to purchase a Virtual DVD for that item.

All of the items which a user has purchased need to be continually available in the future. Instead of keeping particular pieces of content on the VOD server just because that content is present in an individual subscriber's “Virtual DVD Library,” the system could transfer content downstream to edge servers, or to home-based, broadband-connected content storage (e.g., DVR, home media server, PC, etc.). This might occur when only a limited number of users have a particular piece of content in their purchased libraries, in which case it may be more cost-effective to have multiple copies stored on a number of home-based storage devices rather than consuming network bandwidth by a transfer from the headend server farm for each content play.

Where only a limited number of subscribers have selected a particular item, the cable provider may reserve the right to require the user to accept purchase content either of a delivered physical media copy, or by giving the subscriber permission to copy a downloaded copy onto local storage.

Asset Purchasing

The presentation of the catalog of items available for purchase as Virtual DVDs operates as an offer to enter into a legally binding sales agreement. The user's selection of an item from the catalog operates as an acceptance of that offer, creating the contract. The specific terms of the contract are made available to the user in one or more “explanation” displays which may be viewed at any time from the catalog display by selecting a menu choice such as “SEE DETAILS.” In addition, after a selection is made, the user should be provided with a brief summary statement of the terms of the offer, and request confirmation from the user that he or she intends to accept the offer before finalizing the sale. By way of example, the terms of the contract may be restated on a confirmation display as follows:

“You have asked to purchase [item title] as a Virtual DVD. You will be entitled to request and view the content of this movie as often as you like and at any time from [name of cable provider]. In the event you move to another location served by a different participating cable provider, this title, as well as the other titles you have placed in your personal Virtual DVD Library, may be viewed from your new location. If your cable service is terminated for any reason, you will be entitled to receive a copy of each item in your Virtual DVD Library on a physical DVD which will be mailed to you. You also have the right to sell or transfer your Virtual DVD to another subscriber at any time. If you confirm this purchase, the purchase price of $[amount goes here] will appear on your next statement.”

The user may also be given the option to rent rather than purchase the offered item. Rented movies are typically made available for a limited time (e.g. 24 hours) using the cable company's VOD or pay-per-view service. If a movie is rented, it's purchase price as shown in the catalog may be discounted by all or part of the rental charge.

Programs placed in the user's personal Virtual DVD Library may normally viewed only using a specific set-top box, PVR, or home media server. The purchaser is permitted to watch items in the library at any time, but only on an identified device, or other devices associated with the same subscriber and same billing address. A variety of conventional digital rights management (DRM) techniques may be used to protect the content of the Virtual DVD Library against unauthorized use and distribution. In most instances, DRM technologies encrypt digital media content and the associated metadata, and limits access to only those people who have acquired a proper license to play the content, enabling the secure distribution, promotion, and sale of digital media content on the Internet and via cable and satellite distribution systems. See generally, Digital Rights Management: Business and Technology by Rosenblatt, Trippe and Mooney, John Wiley & Sons; 1st edition (2001), ISBN: 0764548891. Systems for providing protection for content delivered by VOD systems are available from a variety of vendors, including Macrovision Corporation, 2830 De La Cruz Boulevard, Santa Clara, Calif. 95050.

DRM technology can apply “copy protection” (encryption) to outgoing content, and download software that activates copy protection features of a set top box, and can permit or preclude copying, and can create copy protected physical DVD disks. Using DRM, the system permits users to enjoy a high quality viewing experience for the consumer but causes any unauthorized copies to be prohibited or substantially degraded.

Once an item is purchased and placed in the subscriber's Virtual DVD Library, it may be viewed without charge as often as the user desires. There may, however, be annual fee for maintaining the library to cover long-term operating costs. Preferably, any such fee would be independent of the number of movies are in the library so that it would not be perceived to be a rental fee.

It may be noted that, under a different model, the “Virtual DVD Library” could be offered as a “block” of virtual storage space, and the user place content title in, or remove content from, this allotted space. Only a single shared copy of the item need exist on the headend video server, but the user would have “virtual” storage space which appeared to be private storage. Under this model, instead of purchasing Virtual DVD titles, the user effectively buys the right to replay any content in a virtual library of specified size, at a cost that varies in relationship to the total amount of virtual content stored in the virtual storage space. The actual storage space used to implement the Virtual Library may exist at the headend, at a hub, or at the client location in a set top box or separate local storage device. The ability to rotate content in and out of the purchased or rented content storage space might be restricted in specified ways. For example, the user might permitted to rotate only a specified percentage (e.g., 20%-per-month), or a limited number of titles, or a limited number of titles in a certain category (e.g., only 2 “New Releases” every month), with different varying levels of restrictions depending on how much the user pays in purchase- or rental-price.

The “Virtual DVD Library” may further provide the user with the ability to purchase a clip or portion of a movie. For example, if there is a particularly funny or exciting scene in a movie, and that is all a user wants to view over and over again, they might purchase or rent just that scene.

The “Virtual DVD Library” may include the ability to purchase different versions of the same content for a reduced (or same) price. For example, the user might have the option of purchasing both Rated-G and Rated-R versions of the same movie, or a “Director's Cut” and “Original Cut” of a movie.

Off-Line Purchasing

As a alternative to, and in addition to, using the catalog viewed on the user's television set, movies can be selected for purchase in a variety of other ways. For example, when users purchase tickets to view a movie in a theater, they could be offered the option of additionally purchasing a discounted Virtual DVD of the same movie, or be given a coupon that is redeemable for a credit when the movie is purchased from their cable provider. This purchase may occur on-line (for example, when buying a movie ticket on from an online ticket vendor), or offline (e.g., in-theater kiosk, or by placing an order by telephone, or by mail). Virtual media purchases could also be offered through a hotel's interactive television system, or the hotel might issue coupons redeemable for a discount toward the purchase of a movie viewed on the hotel's system.

As a corollary, when users purchase a Virtual DVD, they could have the option of also purchasing a discounted movie theater ticket for the same movie at the same time. Currently, movies aren't released to DVD and VOD for many months after they are released to theaters. As a consequence, the user may not actually be able to complete the purchase and obtain access to the Virtual DVD for a number of months after the purchase, but combination purchase (Virtual DVD and movie theater ticket) could nonetheless be offered so that the discount applies to the combination purchase. Incentives (e.g., early screenings, special giveaways, contests, special events, etc.) could be included in the combination purchase to drive sales.

Metadata Enhanced Playback

Customers who purchase Virtual DVDs may also obtain the right to use metadata based enhanced content navigation mechanism. For example, the user may be provided with a detailed guide to the content similar to or equivalent to the scene selection mechanisms supplied with some DVD movies. In addition, the user may be provided with enhanced navigation methods of the type described in co-pending U.S. application Ser. No. 10/165,587 filed Jun. 8, 2002 and published as U.S. patent application Publication No. 20030093790, the disclosure of which is incorporated herein by reference. The enhanced navigation capabilities include:

a. permitting the user to “bookmark” the movies you owned to highlight key scenes or to identify the location where viewing last terminated;

b. permitting subscribers to share bookmarks among themselves;

c. permitting subscribers to save clips or segments of purchased items into a “vault” or “scrapbook” in order to easily access favorite scenes, or later return to a specific part of a purchased item;

d. sending snippets of selected movies to other subscribers as viewing recommendations;

e. playing different, or shortened versions of a program under metadata control;

f. playing predetermined preview segments of purchased items identified by metadata;

g. skipping from one major scene to another as a mechanism for skipping “boring” segments or navigating to a desired segment;

h. creating and playing “playlists” of the favorite portions of a purchased item; and

i. applying parental controls to items in the Virtual DVD Library (such as requiring the entry of a password) for items whose viewing should be restricted to authorized members of the household.

Transferring or Trading Assets

When a physical media volume, such as a DVD disk, is purchased, it may be freely loaned or sold to others, provided copies are not made. When the owner moves or travels, a purchased media volume may be taken to the new location. It is desirable to provide similar capabilities to purchasers of Virtual DVDs.

Thus, if the subscriber you move to another household in the same MSO's (Multiple System Owner's) territory, a mechanism should be provided to allow the user to transfer viewing rights to different set top box. If the owner moves to an area with no service, the user may be supplied with a physical copy of the items in the library, or receive a refund or a different type of credit.

If the virtual asset database (seen at 188 in FIG. 1) serves multiple participating MSOs, a subscriber could switch from one participating MSO to another when changing locations, and the purchased movies would then become available at the new location.

In some cases, when some members of a household change locations while others stay, the system could support the transfer of a subset of the owned collection to a different MSO, so that the items in the owned collection could be treated with the same selective flexibility that applies to an owned collection of physical media disks. In a similar fashion, when people who formerly had separate collections begin to share the same access device, their formerly separate collections may be merged, or treated as separate collections. Assuming that a DRM capability is in place to insure that no copying occurs, purchased items should be freely exchangeable with others.

To facilitate travel, the subscriber may be given a “travel code” upon request when leaving one location. The travel code may then be entered at a destination location to obtain usage at that location, while use at the former location is prohibited. The same mechanism may be used to permanently or temporarily transfer the right to view a purchase asset to another set top box. To prevent misuse of the system, limits may be placed on the number of times a specific item can be transferred in this fashion. These limitations may apply to the number of transfers per movie, per Virtual Library, per time-period, or a combination of these.

On addition, movies could be given away to friends with a fee (less than the cost of the original movie) being charged to new owner, and fees could be charged for both trading and traveling with an owned asset, with part of such fee going back in part to the rights holder.

Conclusion

It is to be understood that the methods and apparatus which have been described above are merely illustrative applications of the principles of the invention. Numerous modifications may be made by those skilled in the art without departing from the true spirit and scope of the invention.

What is claimed is:

1. A method for distributing media content comprising, in combination, the steps of:
storing a collection of media content items in one or more digital storage devices controlled by a content provider and coupled to a specific media presentation device capable of rendering said content items in a form perceptible to a human user,
storing content metadata describing each of said content items,
storing user data describing said user and associating said user with one or more of said media content items,
presenting a catalog to said user by means of said presentation device, said catalog comprising a listing a subset of said content items that are available for purchase by said subscriber from a content provider,
accepting a selection request from said user identifying a particular media content item in said subset that said user seeks to purchase, and
creating and recording a binding sale contract between said user and said content provider which conveys to said user the right to present said particular media content item in perpetuity and obligates said content provider to provide said user with substantially continuous access to said particular media content item as stored in said one or more digital storage devices controlled by said content provider.

2. A method for distributing media content as set forth in claim 1 wherein at least some of said media content items are full length motion pictures and associated content that are also reproduced for commercial sale on digital video disks.

3. A method for distributing media content as set forth in claim 2 wherein said binding sale contract obligates said content provider to enable said user to obtain said particular media content item recorded on one or more digital video disks in the event said continuous access is terminated.

4. A method for distributing media content as set forth in claim 1 wherein at least some of said media content items are collections of music that are also reproduced for commercial sale on compact disk.

5. A method for distributing media content as set forth in claim 1 wherein said continuous access is provided via a cable connection between said one or more digital storage devices and said presentation device.

6. A method for distributing media content as set forth in claim 1 wherein said continuous access is provided via a satellite system providing a transmission path between said one or more digital storage devices and said presentation device.

7. A method for distributing media content as set forth in claim 1 wherein at least one of said storage devices is a video server which stores said particular content item and transmits said particular content item to said presentation device in response to request received from said user.

8. A method for distributing media content as set forth in claim 7 wherein another of said digital storage devices is located on the same premises with said presentation device and receives and stores said particular media item from said content provider.

9. A method for distributing media content as set forth in claim 8 wherein said particular media item is encrypted to provide copy protection which prohibits the high quality presentation of said particular media content item on any presentation device not authorized by said content provider.

10. A method for distributing media content as set forth in claim 1 wherein said binding sale contract obligates said user to pay a specified purchase price for said particular media item wherein said method further comprises the step of collecting said purchase price from said user.

11. A method for distributing media content as set forth in claim 10 wherein, under the terms of said binding sale contract, said user is entitled to a refund of some or all of said purchase price in the event that said content provider is unable to provide said user with substantially continuous access to said particular media content item.

12. A method for distributing media content as set forth in claim 1 wherein said user data identifies the content of a personal purchased media library consisting of each media content item which said user has the right to present in perpetuity as provided in one or more binding sale contracts.

13. A method for distributing media content as set forth in claim 12 wherein said subset of items presented to said user in said catalog excludes the listing of any media content item which already exists in said personal purchased media library.

14. A method for distributing media content as set forth in claim 12 wherein said user data further specifies the location within each media item in said library where said presentation may be commenced or resumed.

15. A method for distributing media content as set forth in claim 12 wherein said user data further specifies number of times said user has presented each media item in said library.

16. A method for distributing media content as set forth in claim 1 further including the step performed prior to said step of presenting a catalog of accepting from said user a designation of the content of said subset.

17. A method for distributing media content as set forth in claim 16 wherein said designation specifies a category to which each item in said subset belongs.

18. A method for distributing media content as set forth in claim 16 wherein said designation specifies a sort order by which the media content items in said subset are to be listed.

19. A method for distributing media content as set forth in claim 16 wherein said designation specifies a subset consisting of media content items previously presented in whole or in part on said presentation device.

20. A method for distributing media content as set forth in claim 16 wherein said designation specifies a subset of media content items previously identified by said user.

21. A method for distributing media content as set forth in claim 1 wherein said particular media item is encrypted to provide copy protection which prohibits the high quality presentation of said particular media content item on any presentation device not authorized by said content provider.
